(19) United States
(12) Patent Application Publication
(10) Pub. No.: US 2025/0211066 A1
(43) Pub. Date: Jun. 26, 2025

(54) ELECTRIC MOTOR WITH ROTARY ENCODER

(71) Applicant: EZ-WHEEL, LA COURONNE (FR)

(72) Inventors: Florian GARDES, GOND-PONTOUVRE (FR); Antoine JUAN, ANGOULEME (FR)

(21) Appl. No.: 18/837,925

(22) PCT Filed: Feb. 13, 2023
(86) PCT No.: PCT/FR2023/050191

§ 371 Date: Aug. 13, 2024

(30) Foreign Application Priority Data
Feb. 14, 2022 (FR) FR2201283

(51) Int. Cl. H02K 11/215; H02K 7/102; H02K 15/40

(52) U.S. Cl. CPC H02K 11/215; H02K 7/102; H02K 15/40; H02K 2203/03; H02K 2211/03

(57) ABSTRACT

The invention relates to an electric motor including a drive shaft carrying a rotor, a device for powering and controlling winding phases of a stator of the motor on an electronic board fixed to the motor, and one or more angle encoders, the angle encoders including sensors positioned on the electronic board and an angular encoding element disposed facing the sensors on the drive shaft, and the electronic board includes power electronics for controlling the windings and a unit for computing and controlling the phase of the windings.

### CROSS REFERENCE TO RELATED APPLICATIONS

This application is a National Stage of International Application No. PCT/FR2023/050191, having an International Filing Date of 13 Feb. 2023, which designated the United States of America, and which International Application was published under PCT Article 21 (2) as WO Publication No. 2023/152457 A1, which claims priority from and the benefit of French Patent Application No. 2201283 filed on 14 Feb. 2022, the disclosures of which are incorporated herein by reference in their entireties.

### BACKGROUND

### Field

The present disclosure relates to the field of the control of electric motors, in particular electric motors driving wheels such as wheels of robotized handling devices and relates to an electric motor provided with a rotary encoder.

### Brief Description of Related Developments

The electric motors driving wheels can be motors controlled by motor control electronics powered by a direct current source like a battery for example. For the purposes of accurately controlling the rotation of the motor, it is useful to know the position and the speed of rotation of the rotor of the motor. Generally, a rotary encoder comprises a revolving part mounted on the shaft of the motor and a sensor for returning this information to the motor control.

The sensor of the encoder is generally fixed to the motor and linked by wire to the motor control electronics disposed in the motor.

### SUMMARY

In particular for robotized handling devices, it is desirable to render the motor and its control electronics more compact, to make the operation of the assembly more reliable and to simplify the reparability of this assembly. The present disclosure proposes, for this, incorporating sensors of a motor rotary encoder in said electronics, the latter being added onto the motor.

Thus, the present disclosure proposes an electric motor comprising a motor shaft bearing a rotor, a device for powering and controlling winding phases of a stator of said motor on an electronic circuit board fixed to the motor and one or more angle encoders, for which said angle encoders comprise sensors positioned on said electronic circuit board and an angle encoding element disposed facing the sensors on the motor shaft, and for which said electronic circuit board comprises power electronics for controlling said windings and a unit for calculating and controlling the phase of said windings.

This makes it possible to produce a block that is compact and can easily be installed while allowing the board to be removed for a possible repair.

The features set out in the following paragraphs can, optionally, be implemented independently of one another or in combination with one another:

According to a first aspect, the electronic circuit board is passed through by the motor shaft. According to an alternative aspect, the electronic circuit board is facing an end of the shaft.

Advantageously, the electronic circuit board is positioned in a removable and replaceable flange, fixed onto a face of a motor casing called rear face, passed through by said motor shaft, said flange comprising a bottom provided with a hole passed through by said motor shaft and a border surrounding the perimeter of the electronic circuit board, said sensors being located facing said angle encoding element borne by said motor shaft.

The angle encoding element is advantageously a multi-pole magnet and the sensors of the magnetic field sensors which avoids having dust or dirt disrupt the measurements.

A rear cap can be fixed to the flange, the rear cap and the flange forming a housing enclosing a space for receiving said electronic circuit board. Thus, the board secured to the motor and the motor shaft are protected.

The flange can comprise a non-magnetic cylindrical wall with an axis in common with the motor shaft disposed between the multi-pole magnet and the sensor or sensors so as to separate and render the housing of said electronic circuit board seal-tight.

The motor shaft can be prolonged by a segment passing through an aperture of the rear cap to produce a support for at least one complementary equipment item.

Said complementary equipment item can be an electromechanical brake comprising a disc and one or more calipers linked and controlled by the electronic circuit board, said calipers being mounted on the rear cap of the block, said disc being mounted on said through-segment.

The present disclosure relates also to an electronic circuit board for an electric motor as described previously which comprises a through-hole for said motor shaft and one or more angle encoder sensors disposed at the periphery of said hole.

The electronic circuit board can comprise power supply connection pins for the windings of the stator adapted to be connected to a connector grouping together the power supply wires of the stator at the flange. Thus, the board is connected easily to the motor power supply cables.

The electronic circuit board can comprise a communication component for communicating with a management system of a handling device of which said motor drives one or more wheels.

The board can be programmed to supply an external computer with speed information, calculations of motor position increments and of motor rotation direction through said communication component.

The present disclosure relates also to a rolling vehicle comprising at least a motor and an electronic circuit board according to any one of the claims as described previously.

The present disclosure relates finally to a method for assembling and calibrating a motor equipped with a board as described which comprises, after assembly of the motor and assembly of the electronic circuit board:
a fixing of the angle encoding element onto the motor shaft, a fixing of the board equipped with the sensors in its final mechanical position on the motor, the relative angular position of the magnet with respect to the sensors of the board being arbitrary and unknown,
a forced rotation of the rotor by applying a revolving magnetic field through control of the stator of the motor with the application of a defined three-phase voltage producing a defined revolving field during a complete revolution,
a measurement by means of the sensors of the states of the magnetic field provoked by the magnet during the forced rotation of the shaft, and a determination by the computation unit of the angular deviation between said states of the magnetic field measured by the sensors and the position imposed in the rotation of the motor by the field applied to the stator;
   the deviations between said measured states and said imposed position being stored in permanent memory in the board and constituting calibration data for a motor/encoder/board assembly.

### BRIEF DESCRIPTION OF THE DRAWINGS

Other features, details and advantages will emerge on reading the following detailed description, and on analyzing the attached drawings, in which:

FIG. 1 shows a schematic cross-sectional side view of an aspect;

FIG. 2 shows a schematic cross-sectional side view according to a complementary aspect;

FIG. 3 shows a perspective view of a motor equipped with an electronic circuit board in a flange;

FIG. 4 shows an example of an annular magnet;

FIG. 5 shows a variant device of the present disclosure.

### DETAILED DESCRIPTION

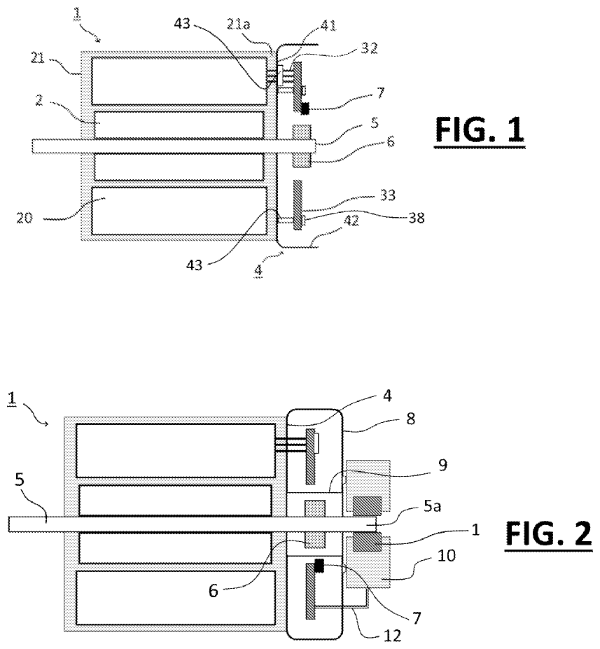

Reference is now made to FIG. 1 which schematically represents, in longitudinal cross-section, an electric motor 1 comprising a rotor 2 on a motor shaft 5 and a stator whose windings 20 are powered by a control device with electronic switches. Such a motor of brushless direct current motor type, known by the abbreviation BLDC motor, is controlled by a converter and is comparable to a direct current motor.

The motor can be, as is known, a brushless three-phase motor whose phases are powered by a power switching system with three MOSFET or IGBT power half-bridges controlled independently by a programmable computer of a device for powering and controlling winding phases of the motor in motor control electronics.

For the purposes of accurately controlling the rotation of the motor, it is useful to know the position and the speed of rotation of the rotor of the motor. Generally, a rotary encoder is mounted on the shaft of the motor to return this information to the motor control. In the example of the present disclosure, notably in FIGS. 1, 2 and 5, the encoder is produced by an integration of magnetic sensors 7 directly on a motor control electronic circuit board 3 facing an angle encoding element 6, here composed of an annular multi-pole magnet, for example a magnet with twelve pairs of poles 6a, 6b as represented in FIG. 4, mounted on the motor shaft 5 facing the sensors which makes it possible to obtain information on the speed and the angular position of the motor directly by the electronics of the control and driving device.

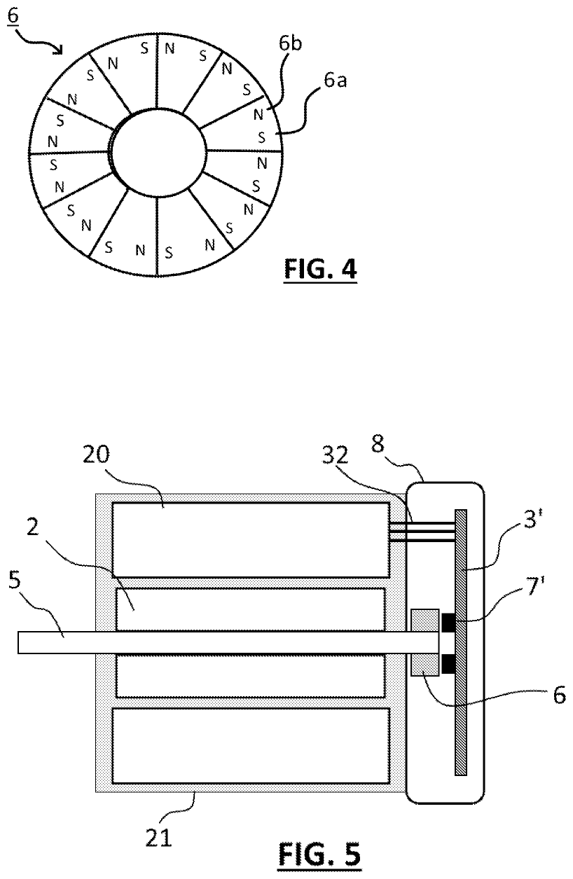

According to FIGS. 1 and 2, the board 3 comprises an aperture to be passed through by the shaft 5, the sensors being at the periphery of the aperture, and, according to FIG. 5, the board 3′ is located facing an end of the shaft, the sensors 7′ being located on a so-called bottom face of the board facing the angle encoding element 6.

The electronic circuit board 3 is, according to the example, mounted in a flange 4 at right angles to an axis of the motor shaft. The flange is disposed on a face 21a of a motor casing 21 at an axial end, called rear end, of the motor, and produces an interface between the rear end of the motor and the electronic circuit board. The flange comprises a bottom wall 41 fixed onto a rear wall 21a of the motor and a border 44, the flange forming a receptacle in which the electronic circuit board 3 is securely fixed and positioned with respect to the motor shaft.

The sensors 7 of the angle encoders are, here, magnetic field sensors such as Hall effect sensors for example, and are positioned on said electronic circuit board facing the annular multi-pole magnet 6 which is itself positioned on the motor shaft 5 passing through said board.

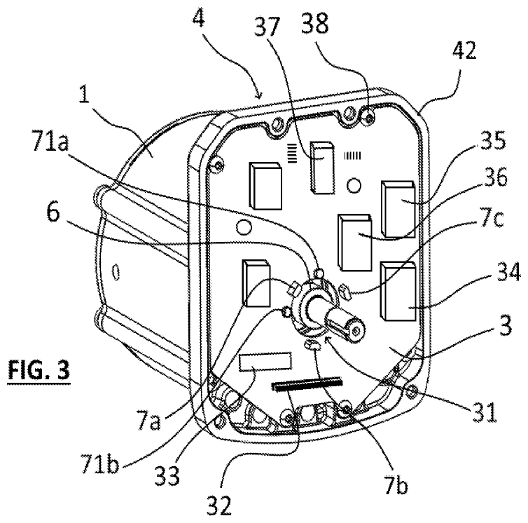

The sensors are of magnetic field sensor type and can notably be Hall effect sensors. Three sensors distributed at 120° around the multi-pole magnet on the motor shaft as represented in FIG. 3 allow for a sufficient accuracy for operation of the motor as means for driving a wheel of a handling device.

A solution with optical encoders comprising optical sensors and an optical encoder wheel can also be envisaged in the context of the present disclosure, or a solution with toothed encoder wheel and magnetic sensors.

The device of the present disclosure has the advantage of combining all the electronic, control and sensor functions of the encoder, in a single mechanical assembly forming a motor control block. The elements of this control block can be assembled separately from the motor, the motor control block becoming a modular functional block which will be directly disposed on the motor at the end of the production line for example. Several motor control block versions can be proposed for a same motor, and the easy replacement of said control block facilitates the maintenance of the device.

According to the example of FIG. 1, the electrical phase cables of the motor are connected via a connector 43 mounted on the flange and receiving contact pins 32 coming from the electronic circuit board to facilitate the mounting and the replacement of the motor control block or of the electronic circuit board. These cables can be connected directly to the electronic circuit board 3 as represented in FIG. 2.

FIG. 2 represents an aspect for which a rear cap 8 is fixed to the flange, this rear cap and the flange forming a housing enclosing a space for receiving said electronic circuit board which protects it from external attacks.

It is also possible to provide a non-magnetic cylindrical wall 9 with an axis in common with the motor shaft 5 disposed between the multi-pole magnet and the sensor or sensors, which makes it possible to render the housing of said electronic circuit board seal-tight and even better protect it.

Still according to the variant of FIG. 2, the motor shaft can be prolonged by a segment 5a passing through an aperture of the rear cap 8 to produce a support of at least one complementary equipment item which can be an electromechanical brake comprising a disc 11 and one or more calipers 10 linked and controlled by the electronic circuit board.

In this example, the calipers are mounted on the rear cap 8 of the control block and the disc is mounted on said through-segment 5a.

FIG. 3 represents the mounting of the electronic circuit board 3 in the flange 4 at the rear of the motor, this board being, for example, fixed onto spacers 43 of the flange by screws 38.

The board comprises a hole 31 to allow the multi-pole magnet 6 to pass through and the sensors 7a, 7b, 7c are disposed around said magnet at the periphery of the hole.

The electronic circuit board further comprises power electronics 33 and a computation unit 34 such as a microprocessor or a microcontroller, associated with a permanent memory 35, for example of EEPROM type to be able to be updated, comprising the program for controlling the motor and the calibration data and a random-access memory 36, for controlling the phases of the motor. The board possibly comprises a communication component 37, for example a component for managing field buses of CAN or Ethernet type, or even a radio link such as Wi-Fi, Bluetooth, Zigbee, even 5G linked to the computation unit and to an antenna not represented or a wire link component linking the electronic circuit board with a controlling computer on a rolling piece of equipment such as a handling device comprising one or more motors of the present disclosure for driving the wheels of said piece of equipment to allow the electronic circuit board to communicate with a management system of said rolling piece of equipment that is remote or embedded.

According to one important aspect, the device as represented does not include mechanical angular position setting between the multi-pole magnet and the windings of the motor. A self-calibration procedure is carried out once the electronic circuit board is assembled on the motor to know the angular position of the rotor and control the phases of the stator with respect to the rotor which is important for maximizing the motor start-up torque.

The self-calibration procedure is carried out either at the output of the production line or during the first commissioning of the product, following the pairing of the sensor electronic assembly and of the motor supporting on its axis the means giving the position information, multi-pole magnet, encoder wheel or the like.

For this procedure:
after assembly of the motor and assembly of the electronic circuit board:
   the angle encoding element 6 is fixed onto the motor shaft, for example by gluing, and the board 3 is disposed in its final mechanical position on the motor. After these operations, the relative angular position of the encoding element, for example a multi-pole magnet, with respect to the sensors 7 of the board, is arbitrary and unknown.

Next, the rotor 2 is rotated by applying a magnetic field by controlling the stator 20 of the motor with the application of a defined three-phase voltage producing a defined revolving field and the position of the motor is thus imposed during one complete revolution;

During the forced rotation of the shaft, the sensors 7 measure the states of the magnetic field provoked by the magnet, and the computation unit 34 determines the angular deviation between said states measured by the sensors and the position imposed in the rotation of the motor by the field applied to the stator;

The deviations between said measured states and said imposed position are stored in permanent memory (35) in the board and constitute the calibration data for a motor/encoder/board assembly.

The procedure is totally automated and makes it possible to overcome variations linked to mechanical assembly by the determination of the parameters allowing for the shaping or normalization of the signal received by the sensor or sensors.

The procedure then makes it possible to correlate information from the sensor with the position of the rotor of the motor, allowing for the use of the information from this sensor for the generation of the revolving magnetic field used for the control of the motor.

According to the example of FIG. 3, the encoder device comprises three logic sensors 7a, 7b, 7c offset by 120° facing the annular multi-pole magnet with 12 pairs of poles which gives six recombinant states, i.e a 72° relative position for a basic control of the motor. The number of pairs of poles can however be greater for greater accuracy. To obtain greater accuracy, two analog sensors 71a, 71b disposed at 90° in sine/cosine can be added facing the multi-pole magnet or the number of logic sensors can be increased. The positioning of the sensors directly on the electronic circuit board avoids having electrical link cables between the latter and said board and renders the mounting more robust against vibrations in particular.

For applications requiring significant operating safety, it is also possible to use additional redundancy sensors side-by-side, sensors supplying redundant measurements, or a safety encoder with a safety controller.

In a case where a zero rotation point of the motor is desirable, a sensor, for example an additional magnetic sensor, can be disposed facing a pin or a groove on the metal shaft.

The present disclosure is not limited to the examples represented and in particular the electronic circuit board can be subdivided into modules for better reparability.

What is claimed is:

1. An electric motor comprising a motor shaft bearing a rotor, a device for powering and controlling winding phases of a stator of said motor on an electronic circuit board fixed to the motor and one or more angle encoders, characterized in that said angle encoders comprise sensors positioned on said electronic circuit board and an angle encoding element disposed facing the sensors on the motor shaft, and in that said electronic circuit board comprises power electronics for controlling said windings and a unit for calculating and controlling the phase of said windings.

2. The electric motor as claimed in claim 1 for which the electronic circuit board is passed through by the motor shaft.

3. The electric motor as claimed in claim 1 for which the electronic circuit board is positioned in a removable and replaceable flange, fixed onto a face of a motor casing, called rear face, passed through by said motor shaft, said flange comprising a bottom provided with a hole passed through by said motor shaft and a border surrounding the perimeter of the electronic circuit board, said sensors being located facing said angle encoding element borne by said motor shaft.

4. The electric motor as claimed in claim 1 for which the angle encoding element is a multi-pole magnet and the sensors of the magnetic field sensors.

5. The electric motor as claimed in claim 1 comprising a rear cap fixed to the flange, the rear cap and the flange forming a housing enclosing a space for receiving said electronic circuit board.

6. The electric motor as claimed in claim 1 for which the flange comprises a non-magnetic cylindrical wall with an axis in common with the motor shaft disposed between the multi-pole magnet and the sensor or sensors so as to separate and render the housing of said electronic circuit board seal-tight.

7. The electric motor as claimed in claim 1 for which the motor shaft is prolonged by a segment passing through an aperture of the rear cap to produce a support for at least one complementary equipment item.

8. The electric motor as claimed in claim 7 for which said complementary equipment item is an electromechanical brake comprising a disc and one or more calipers linked and controlled by the electronic circuit board, said calipers being mounted on the rear cap of the block, said disc being mounted on said through-segment.

9. An electronic circuit board for an electric motor as claimed in claim 1, characterized in that it comprises a hole for the passage of said motor shaft and one or more angle encoder sensors disposed at the periphery of said hole.

10. The electronic circuit board as claimed in claim 9 comprising pins for connecting the power supply of the windings of the stator adapted to be connected to a connector grouping together the power supply wires of the stator at the flange.

11. The electronic circuit board as claimed in claim 9 comprising a communication component for communicating with a management system of a handling device of which said motor drives one or more wheels.

12. The electronic circuit board as claimed in claim 11 for which the board is programmed to supply an external computer with speed information, calculations of motor position increments and of motor rotation direction through said communication component.

13. A rolling vehicle comprising:
at least an electric motor comprising a motor shaft bearing a rotor, a device for powering and controlling winding phases of a stator of said motor on an electronic circuit board fixed to the motor and one or more angle encoders, characterized in that said angle encoders comprise sensors positioned on said electronic circuit board and an angle encoding element disposed facing the sensors on the motor shaft, and in that said electronic circuit board comprises power electronics for controlling said windings and a unit for calculating and controlling the phase of said windings; and
an electronic circuit board comprising a hole for the passage of said motor shaft and one or more angle encoder sensors disposed at the periphery of said hole.

14. A method for assembling and calibrating an electric motor comprising a motor shaft bearing a rotor, a device for powering and controlling winding phases of a stator of said motor on an electronic circuit board fixed to the motor and one or more angle encoders, characterized in that said angle encoders comprise sensors positioned on said electronic circuit board and an angle encoding element disposed facing the sensors on the motor shaft, and in that said electronic circuit board comprises power electronics for controlling said windings and a unit for calculating and controlling the phase of said windings, the electric motor equipped with an electronic circuit board comprising a hole for the passage of said motor shaft and one or more angle encoder sensors disposed at the periphery of said hole, characterized in that the method comprises, after assembly of the motor and assembly of the electronic circuit board:
a. a fixing of the angle encoding element on the motor shaft, a fixing of the board equipped with the sensors in its final mechanical position on the motor, the relative angular position of the magnet with respect to the sensors of the board being arbitrary and unknown,
b. a forced rotation of the rotor by applying a revolving magnetic field by controlling the stator of the motor with the application of a defined three-phase voltage producing a defined revolving field during a complete revolution,
c. a measurement by means of the sensors of the states of the magnetic field provoked by the magnet during the forced rotation of the shaft, and a determination by the computation unit of the angular deviation between said states of the magnetic field measured by the sensors and the position imposed in the rotation of the motor by the field applied to the stator;
the deviations between said measured states and said imposed position being stored in permanent memory in the board and constituting the calibration data for a motor/encoder/board assembly.
